(19) United States
(12) Patent Application Publication
(10) Pub. No.: US 2015/0195175 A1
(43) Pub. Date: Jul. 9, 2015

(54) METHOD AND APPARATUS FOR PROVIDING REMOTE SUPPORT FOR AN EMBEDDED SYSTEM

(71) Applicant: Alexander V. Kariman, (US)

(72) Inventor: Alexander V. Kariman, Rockville, MD (US)

(73) Assignee: SAFE FRONTIER LLC, McLean, VA (US)

(21) Appl. No.: 14/148,449

(22) Filed: Jan. 6, 2014

(51) Int. Cl. H04L 12/26

(52) U.S. Cl. CPC H04L 43/10

(57) ABSTRACT

The present disclosure provides a method and apparatus that permits remote personnel to service embedded systems over the Internet, for example to monitor and troubleshoot an embedded system or perform interactive field diagnostics and repair using an alternate interaction method and apparatus that allows to interact with the embedded system's modules and interfaces to provide support and maintenance services that may help to avoid dispatching a technician onsite.

### FIELD OF THE INVENTION

The present invention generally relates to serving resource constrained and full capability embedded systems, and particularly relates to remotely servicing an embedded device or a system, for example: office or domestic appliance, industrial equipment, intelligent sensor, micro and macro embedded systems, intelligent meters, controllers, network gear, embedded automotive, marine, and aerospace equipment, POS and retail equipment, ATM and banking, digital signage, surveillance, infotainment, medical equipment, critical embedded systems, embedded systems equipped with a radio module, including cellular radio, embedded systems used in automation equipment, energy, special and general purpose embed systems, and alike.

### BACKGROUND

Embedded systems play an increasingly important role in the human life and the economy. While the capabilities and uses of embedded systems vary widely, many embedded systems operate behind the scenes often deeply integrated in other equipment or located in the hard to reach and provide service areas. An example would be an autonomous system designed to operate far remote for a prolonged period of time. Importantly, embedded systems are not user devices, e.g., they do not directly or at all interface a user-cornerstone of today's security paradigm, and could be managed by other machines. In addition, embedded systems often do not provide built-in operator interface, making their servicing even more difficult. Embedded systems just like all other computing devices need to be secured, serviced, updated, and service providers need to have convenient means to respond to an operating emergency. Indeed, one of the constraining factors of wide proliferation of embedded systems into the untraditional application areas is the lack of sufficient and/or cost-efficient management controls to provide adequate security, maintenance, and emergency response services.

One consequence of this inscrutability is that detailed diagnosis of an embedded system's operation oftentimes requires direct interaction with the embedded device by a technician or other skilled operator. Operator uses specialized software that facilitates access to the inner workings of the device. If the embedded system is powered off or the operating system hung or crashed, little can be done without technician's physical access to the embedded system. While some embedded devices provide remote access, such access is oftentimes limited to a local network, provides rudimentary interaction with the device, and generally does not enable diagnostic or repair if the operating system is not functioning or the processor is off.

Whilst a variety of technical support systems are known for user electronic devices, for example: U.S. Pat. No. 8,078,670 B2 (Publication date Jun. 29, 2011); U.S. Pat. No. 7,676,035 B2 (Publication date Mar. 9, 2010); U.S. Pat. No. 7,676,035 B2 (Publication date Mar. 9, 2010); including support systems that enable remote support of a switched off personal computer (PC) or a PC without using an operating system stored within said PC, U.S. Application No. 20110161721 A1 (Publication date Jun. 30, 2011); further, U.S. Pat. No. 6,438,711 B2 (Publication date Aug. 20, 2002) that provides a method, system, and apparatus for managing a computer system by initiating reset of the computer system from a remote location; and running diagnostic software on the computer system downloaded from the remote location, and U.S. Pat. No. 7,010,594 B2 (Publication date Mar. 7, 2006) where the disclosure provides a system and apparatus for the remote monitoring and control of a computing component where a transceiver is attached to a computing component that operates independently of the computing component by maintaining its own processing power, memory, power supply and communications capabilities. Another method is providing support for a computing device using active management technology Pat. No. DE 10 2008 059 485 (Publication dated Jul. 9, 2009). This method involves installing on the computing device the active management technology (Active Management Technology) that consists of two components, namely, special software and special equipment installed on the computing device chipset. This method makes possible to remotely access the content on the computing device, even if the computing device is switched off, but connected to a power source. Another known method and system for managing a computer node out-of-band U.S. Pat. No. 8,312,126 B2 (Publication dated Nov. 13, 2012) includes a device configured to perform compute-intensive tasks in one computing node and another device that is external to the managed computing node configured to perform administration operations for the first device and the second device. Another known apparatus and method for computer management is US Application. No. 20080137658 A1 (Publication dated Jun. 12, 2008) and involves baseboard management controller (BMC) connected through a network to provide remote management.

Technical support systems for embedded devices commonly require a specialized diagnosing unit or a local computer to be communicatively coupled by a cable or attached to a network with the diagnosed embedded system to perform diagnosis of the embedded system. In addition, this approach does not readily allow the Internet-based remote technician to be automatically alerted of the embedded system operating status. Furthermore, prior art does not consider the resource constraints of the new generation embedded devices, including communication network constraints, size constraints, power supply constraints, processing power constraints, cost constraints, etc. Nor it considers the servicing aspects of quickly proliferating small embedded devices and the new use-models where there could be a multitude of service providers and data consumers.

### DESCRIPTION OF THE INVENTION

The present invention provides an improved method and apparatus for supporting remote servicing of embedded systems. According to an aspect of the present invention, there is a method and apparatus for remotely supporting an embedded system that includes among other components an operating system responsible for operating the embedded system. In addition, it includes an independent program of instructions or an operating system that works independent of the embedded system's operating system. It also includes a diagnostic and/or data harvesting engine or the steps of providing a diagnostic and/or data harvesting engine for the embedded system. Such engine includes at least one procedure for diagnosing the operational state of the embedded system, and/or altering configuration of the embedded system, and/or harvesting data relating to the embedded system. There is also network access software that is independent of the embedded system's operating system that can access a website via the Internet to exchange data with the website related to the procedure, where such data can be accessed by an application and/or personnel.

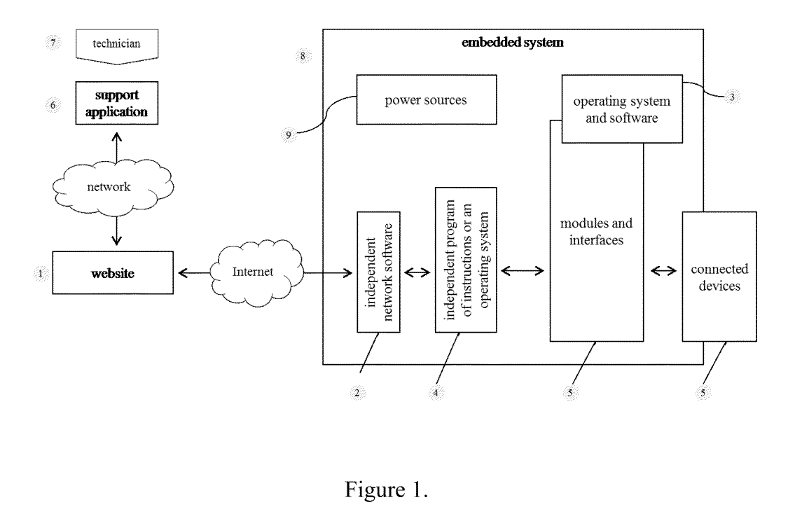

FIG. 1 illustrates an exemplary embodiment of the method and apparatus that supports remote servicing and diagnostics for embedded systems. A support website 1 interacts with the independent network software 2 that is separate from the embedded system's operating system 3. Such independent network software 2 interacts with the program of instructions or an operating system 4 that is separate from the operating system 3 that operates the embedded system 8. Such independent program of instructions or an operating system 4 interacts with the embedded system's internal modules, interfaces, and devices connected to the embedded system 5. The independent program of instructions or an operating system 4 executes support procedures and transmits data regarding the procedures to the independent network software 2. The independent network software 2 transmits over the Internet the aforementioned data to the support website 1 where a support application 6 and a support technician 7 can access and process such data automatically or manually. A support technician 7 interacts with the embedded system 8 and its respectful modules, interfaces, and connected devices 5 via the independent program of instructions or the operating system 4, further, via the independent network software 2, the support website 1, and a support application 6.

FIG. 1 further illustrates an exemplary embodiment of the apparatus that supports remote servicing and diagnostics for embedded systems, where in one embodiment such apparatus may have the independent network software 2 and/or the independent program of instructions or the operating system 4 that is separate from the operating system 3 that operates the embedded system 8, being integrated into the embedded system's electronic circuitry and/or silicon. In one embodiment of such apparatus, the processor that operates the independent network software 2 and/or the independent program of instructions or the operating system 4 is powered by the same power sources that power the embedded system 9.

FIG. 1 further illustrates an exemplary embodiment of the apparatus where the independent program of instructions or the operating system 4 can interact with the embedded system's modules, interfaces, and connected devices 5, including the interfaces of the operating system 3 that operates the embedded system 8 and the software that is executed in such operating system 3.

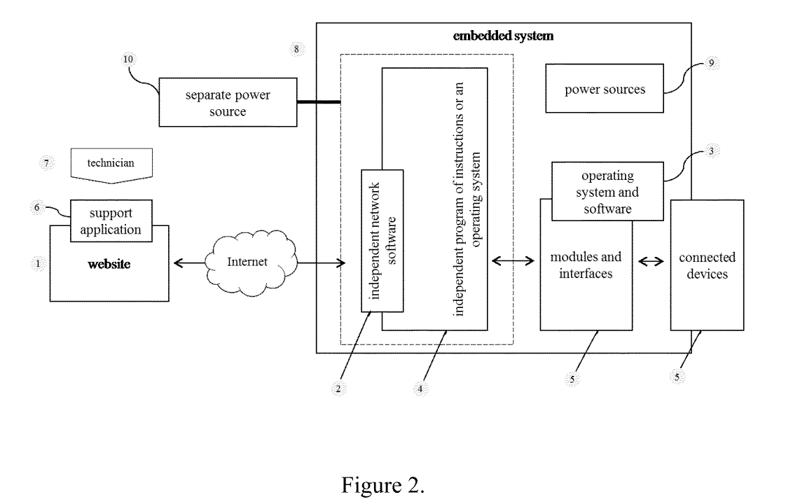

FIG. 2 illustrates an exemplary embodiment of the disclosed method and apparatus where the independent network software 2 is executed within the program of instructions or an operating system 4 that is separate from the operating system that operates the embedded system 3.

FIG. 2 further illustrates an exemplary embodiment of the disclosed method and apparatus where the support website 1 and the support application 6 are operably coupled.

FIG. 2 further illustrates an exemplary embodiment of the disclosed method and apparatus where the processor that operates the independent network software 2 and/or the independent program of instructions or the operating system 4 is powered by a separate power source 10 than the embedded system.

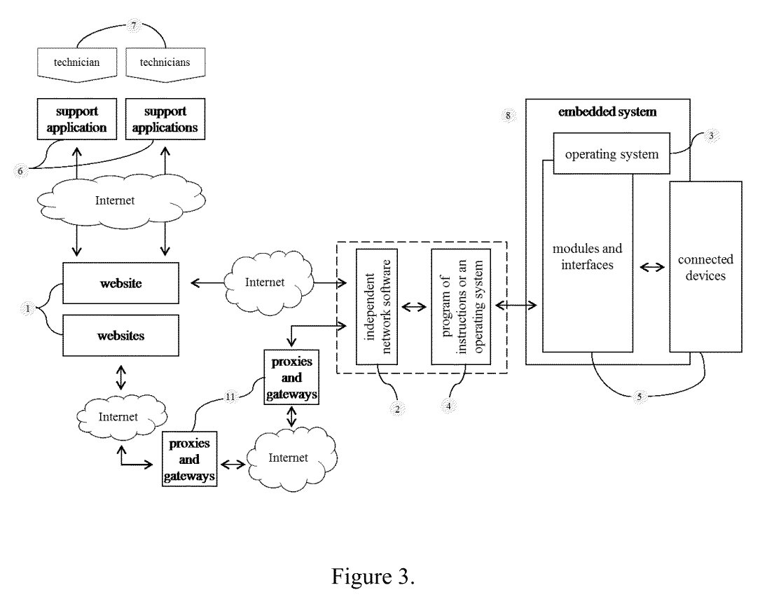

FIG. 3 illustrates an exemplary embodiment of the disclosed method and apparatus where the independent network software 2 may connect consecutively or concurrently and exchange data with plurality of websites 1. In some embodiment, the plurality of applications 6 may connect and exchange data with the website 1. In some embodiment, the access of applications 6 to the website 1 can be accessed controlled. Further, in some embodiment, the plurality of technicians 7 may interact with the application 6.

FIG. 3 illustrates an exemplary embodiment of the disclosed method and apparatus where the independent network software 2 may connect to the website 1 via any number of physical and/or logical intermediaries of various types, such as proxies and/or gateways 11, including: web proxies, caching proxies, translation proxies, encryption proxies, filtering proxies, transparent proxies, DNS proxies, home gateways, Internet gateways, industrial gateways, office gateways, cellular gateways, wireless gateways, modems, repeaters, signal extenders, routers, switches, firewalls, peered network-enabled computing devices, etc.

FIG. 3 further illustrates an exemplary embodiment of the disclosed apparatus, where the independent network software 2 and/or the independent program of instructions or the operating system 4 that is separate from the operating system 3 that operates the embedded system 8, being communicatively coupled with the interfaces of the embedded system in a way that make possible to operate independently of the embedded system's operating system 3, but not being a part of the electronic circuitry of the embedded system 8. Therefore it is possible to disengage and/or remove the media with the independent network software 2 and/or the independent program of instructions or the operating system 4 from the embedded system 8.

In one exemplary embodiment, a service program running on an embedded system independent of the embedded system's operating system enables diagnostic interaction between the embedded system and a remote support application via the Internet. The service program executing on the embedded system allows automated or manual detailed diagnostic interaction between the remote support application and the embedded system regardless of the state of the embedded system's operating system. Further, in at least some exemplary embodiment, the method and apparatus may support two-way interaction between a remote support application and an embedded system where the application may receive an alert from the embedded system or an error code message and the application may activate certain logic and respond automatically by transmitting any number of command instructions and parameters to the managed embedded system.

In another exemplary embodiment, the disclosed method and apparatus may support interaction between a remote technician and an embedded system where a technician can view the embedded system's display screens that also may allow the entry and display of operator input and service feedback at both locations.

In another exemplary embodiment, the disclosed method and apparatus may support interaction between a remote technician and an embedded system where a technician exchanges service and security related data with the embedded system's internal modules and interfaces or connected devices, such as, but not limited to environmental sensors, surveillance sensors, geo-positioning sensors, gyroscopic sensors, radiofrequency sensors, tampering detection sensors, video and audio sensors, and any other sensors, as well as exchanging data through the embedded system's interfaces and with modules such as, video, audio, network cards, radio modules, including cellular radio, attached or internal data storage media, displays, controls, actuators, and peripheral devices coupled with the managed embedded system.

In another exemplary embodiment, the disclosed method and apparatus may support interaction between a remote technician and an embedded system where a technician receives service and security related data from the embedded system's volatile and/or non-volatile memory, for example to receive an operating system's crash dump, log file or a memory image and may respond by sending data to be written into volatile and/or non-volatile memory of the embedded system.

In another exemplary embodiment, the disclosed method and apparatus may support interaction between a remote technician and an embedded system where a technician can receive and inject data packets from/into the communication traffic between the embedded system's operating system and the communication networks it interfaces.

In another exemplary embodiment, the disclosed method and apparatus may support interaction between a remote technician and an embedded system where a technician can receive data packets of the video and audio data traffic between the embedded system's operating system and audio/video devices it interfaces; and if necessary, remotely transmit data to such video and audio devices; for example, to provide appropriate video/audio content for a digital signage system while the system's operating system is being repaired.

In another exemplary embodiment, the disclosed method and apparatus may support automated and manual interaction between a remote technician and an embedded system where a technician can receive data, send commands, and otherwise interact with the embedded system's hardware, firmware, and software regardless of the operating state of the embedded system's operating system to provide management and security services.

In another exemplary embodiment, the disclosed method and apparatus may support interaction between a remote technician and an embedded system where a technician can carry out repair or replacement of software and/or firmware of the embedded system, including the software and/or firmware of the independent program of instructions or an operating system and/or the independent network access software, including providing patches, updates, downgrades, and upgrades.

In another exemplary embodiment, the disclosed method and apparatus may support interaction between a plurality of independent remote technicians using independent support applications and a single embedded system; as such, several separate technical support organizations can interact with the embedded system to provide support services in their respective domains.

In another exemplary embodiment, the disclosed method and apparatus may support interaction between a remote technician and an embedded system where a technician can interact with the embedded system over the Internet using a debugging apparatus, as if the embedded system was communicating with the debugging apparatus, as if it was in the local network with said debugging apparatus or the debugging apparatus was physically attached to one of the communicative interfaces of the embedded system.

In another exemplary embodiment, the disclosed method and apparatus may support interaction between a remote technician and an embedded system where a technician can interact with the embedded system independently of the embedded system's operating system to access software, such as an application server, running in the operating system that operates the embedded system. A technician can then interact with the software, for example an application server, over the Internet as if the technician was interacting with such software through a network stack of the operating system that operates the embedded system and runs the said software.

In another exemplary embodiment, the disclosed method and apparatus may support interaction between a remote technician and an embedded system where a technician can interact with the embedded system to control its functional characteristics as to provide certain maintenance tasks; for example, when a technician deactivates a component of the embedded system in order for it not to interfere with the maintenance procedure.

Of course, many exemplary variations may be practiced with regard to establishing such interaction. The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

What claimed is:

1. A method of supporting remote service of embedded systems, having:
at least one processor that operates the embedded system; and
a communications interface operably coupled with the processor that operates the embedded system; and
an operating system for operating the embedded system, and
an independent program of instructions or an operating system, which includes diagnostic and/or data harvesting engine or the steps of providing a diagnostic and/or data harvesting engine for the embedded system, which includes at least one procedure for diagnosing the operational state of the embedded system, and/or altering configuration of the embedded system, and/or harvesting data related to the embedded system; and
network access software, which accesses the Internet from the embedded system, initiating the connection and operates independently of the operating system that operates the embedded system, and uses said Internet access to access a website over the Internet, exchanging data with the website related to the procedure, where such data is accessed by an application and/or personnel.

2. A method according to claim 1, wherein the website is accessed via a proxy and/or a gateway.

3. A method according to claim 1, wherein the website is accessed via at least one peered network-enabled computing device.

4. A method according to claim 1, wherein the website is accessed when the processor that operates the embedded system and/or operating system that operates the embedded system is switched off, inoperable, or malfunctions.

5. A method according to claim 1, wherein the independent network access software of the embedded system accesses and exchanges data related to the procedure with more than one website.

6. A method according to claim 1, wherein the independent network access software transmits an identifier for identifying an Internet location where the results of the procedure are located.

7. A method according to claim 1, wherein the website and/or application includes a step of providing for the support service to issue a command instruction, and/or carry out repair or replacement of software and/or firmware of the embedded system.

8. A method according to claim 1, wherein a website includes at least one of: a computing device, a data storage medium, a web server, an email server, a file server, an application server, a message gateway, a proxy gateway, a server that stores the results of the procedure in a database, a database.

9. A method according to claim 1, wherein the independent Internet access software includes at least one of: a LAN driver, a WAN driver, a WWAN driver, a TCP/IP stack, an HTTP stack, a UDP stack, network security software.

10. A method according to claim 1, wherein the independent Internet access software provides access by at least one of: HTTP, FTP, TELNET, SOCKS, VNC, OMA DM, TLS, SSL, WS-Management, SNMP, VPN, Common Industrial Protocol, Modbus, Ethernet/IP, PROFIBUS, PROFINET, DeviceNet, CAN, protocols capable of Multiple Recipient/Multicast/Broadcast addressing, pear to pear communication protocols.

11. A method according to claim 1, wherein the independent Internet access software communicates with the website Out of Band (OOB).

12. A method according to claim 1, wherein the independent Internet access software uses one of: DHCP and static IP.

13. A method according to claim 1, wherein the method includes a step of transmitting embedded system management and/or security data to the website.

14. A method according to claim 1, wherein the method includes a step that allows the website to uniquely identify the embedded system.

15. A method according to claim 1, wherein the method includes a step of transmitting to the website video imagery of at least one embedded system-attached or embedded video display.

16. A method according to claim 1, wherein the method includes a step of transmitting to the website video and/or audio data from at least one attached or embedded video and/or audio acquisition device.

17. A method according to claim 1, wherein the method includes a step of exchanging data between at least one embedded system's module, interface, and/or connected to the embedded system device and the website.

18. A method according to claim 1, wherein the independent program of instructions or an operating system, and/or diagnostic and/or data harvesting engine is provided from one or more of: a boot disc, a hidden partition in a hard disc drive of the embedded system, volatile, and non-volatile data storage media, a remote network location, a USB device.

19. A method according to claim 1, wherein the independent program of instructions or operating system is executed by a service processor communicatively and/or operably coupled with the embedded system.

20. A method according to claim 1, wherein the support personnel is one of a user or owner of the embedded system.

21. An apparatus for providing remote service of embedded systems, having:
at least one processor that operates the embedded system; and
a communications interface operably coupled with the processor that operates the embedded system; and
an operating system for operating the embedded system, and
an independent program of instructions or an operating system, which includes diagnostic and/or data harvesting engine or the steps of providing a diagnostic and/or data harvesting engine for the embedded system, which includes at least one procedure for diagnosing the operational state of the embedded system, and/or altering configuration of the embedded system, and/or harvesting data related to the embedded system; and
network access software, which accesses the Internet from the embedded system, initiating the connection and operates independently of the operating system that operates the embedded system, and uses said Internet access to access a website over the Internet, exchanging data with the website related to the procedure, where such data is accessed by an application and/or personnel.

22. An apparatus according to claim 21, wherein a website includes at least one of: a computing device, a data storage media, a web server, an email server, a file server, an application server, a message gateway, a proxy gateway, a server that stores the results of the procedure in a database, a database.

23. An apparatus according to claim 21, wherein the independent Internet access software includes at least one of: a LAN driver, a WAN driver, a WWAN driver, a TCP/IP stack, an HTTP stack, a UDP stack, and network security software.

24. An apparatus according to claim 21, wherein the independent Internet access software provides access by at least one of: HTTP, FTP, TELNET, SOCKS, VNC, OMA DM, TLS, SSL, WS-Management, SNMP, VPN, Common Industrial Protocol, Modbus, Ethernet/IP, PROFIBUS, PROFINET, DeviceNet, CAN, protocols capable of Multiple Recipient/Multicast/Broadcast addressing, and pear to pear communication protocols.

25. An apparatus according to claim 21, wherein the independent Internet access software is capable of communicating with the website using Out of Band (OOB) communication channel.

26. An apparatus according to claim 21, wherein the independent Internet access software uses one of DHCP and static IP.

27. An apparatus according to claim 21, wherein at least one of: the diagnostic and/or data harvesting engine is capable of generating, and the independent network access software is capable of transmitting the embedded system configuration and/or security data to the website.

28. An apparatus according to claim 21, wherein the independent network access software allows the website to uniquely identify the embedded system.

29. An apparatus according to claim 21, wherein the independent network access software transmits video imagery of at least one embedded system-attached or embedded video display to the website.

30. An apparatus according to claim 21, wherein the independent network access software transmits video and/or audio data from at least one embedded system-attached or embedded video and/or audio acquisition device to the website.

31. An apparatus according to claim 21, wherein the independent Internet access software is capable of exchanging data with the embedded system's modules, interfaces, and connected to the embedded system devices and the website.

32. An apparatus according to claim 21, wherein the independent program of instructions or the operating system is capable of exchanging data with the operating system that operates the embedded system and/or software that is executed in the operating system that operates the embedded system.

33. An apparatus according to claim 21, wherein the independent program of instructions or an operating system, and/or diagnostic and/or data harvesting engine is provided from one or more of: a boot disc, a hidden partition in a hard disc drive of the embedded system, volatile, and non-volatile storage media, a remote network location, a USB device.

34. An apparatus according to claim 21, wherein at least one of: the diagnostic and/or data harvesting engine is capable of operating, and the independent network access software is capable of communicating with the website when the processor that operates the embedded system and/or operating system that operates the embedded system is switched off, inoperable, or malfunctions.

35. An apparatus according to claim 21, wherein the diagnostic and/or data harvesting engine exchanges data with Baseboard Management Controller (BMC), and/or System Management Module (SMM) of the embedded system.

36. An apparatus according to claim 21, wherein the independent program of instructions or operating system is executed by a service processor coupled with the embedded system.

37. Apparatus according to claim 21, including at least one of: a comparison database and an update database coupled to the support application for providing correct versions and updates, respectively, of software and firmware.
